(19) United States
(12) Patent Application Publication
(10) Pub. No.: US 2022/0043849 A1
(43) Pub. Date: Feb. 10, 2022

(54) DOCUMENT PROCESSING PROGRAM AND INFORMATION PROCESSING APPARATUS

(71) Applicant: LegalForce Inc., Tokyo (JP)

(72) Inventors: Takashi KAWATO, Tokyo (JP); Ruka FUNAKI, Tokyo (JP)

(21) Appl. No.: 17/510,291

(22) Filed: Oct. 25, 2021

Related U.S. Application Data
(63) Continuation of application No. PCT/JP2019/034158, filed on Aug. 30, 2019.

(30) Foreign Application Priority Data
May 22, 2019 (JP) 2019-095648

(51) Int. Cl. G06F 16/34; G06K 9/00; G06F 40/30; G06F 40/268

(52) U.S. Cl. CPC G06F 16/345; G06F 40/268; G06F 40/30; G06K 9/00469

(57) ABSTRACT

A document processing program and an information processing apparatus that present a contract status of an organization based on the contents of contract documents. The document processing program including instructions that causes the information processing apparatus to: accept a condition for analyzing a contract document by an acceptance unit; extract a contract document by an analysis target extraction unit, wherein the contract document containing extraction information matching the condition accepted by the acceptance unit from a contract document database which includes a plurality of contract documents and in which information indicating a contract status of the plurality of contract documents is extracted as extraction information; analyze the contract document extracted by the analysis target extraction unit based on the condition accepted by the acceptance unit, by an analysis unit; and display and output an analysis result of the analysis unit by the output unit.

### CROSS-REFERENCE TO RELATED APPLICATIONS

The present application is a bypass continuation application based on and claims the benefit of priority from the prior Japanese patent application No. 2019-095648 filed on May 22, 2019, and PCT Application No. PCT/JP2019/034158 filed Aug. 30, 2019, the entire contents of which are incorporated herein by reference.

### TECHNICAL FIELD

The embodiments relate to a document processing program and an information processing apparatus.

### BACKGROUND ART

As a conventional technique, an information processing apparatus that detects a keyword from a contract document and notifies a contractor of a risk in advance has been proposed (see, for example, Patent Literature 1).

The information processing apparatus disclosed in Patent Literature 1 detects predetermined keywords from a document of a contract document, recognizes an important portion for a user who makes a contract from among the detected keywords, and presents the important portion together with a risk to cause the user to determine whether or not to conclude the contract. In addition, when detecting an update deadline or the like of the contract from the document of the contract document, the information processing apparatus presents an update setting screen and causes the user to determine whether or not to notify the update.

### CITATION LIST

### Patent Literature

Patent Literature 1: WO 2018/042548 A1

### SUMMARY OF INVENTION

### Technical Problem

The information processing apparatus of Patent Literature 1 described above detects a keyword from a contract document and notifies a contractor of a risk in advance and causes the contractor to determine the necessity of update notification of the contract document. However, the information processing apparatus is intended for a single contract document, and is not intended for a plurality of contract documents. There has been a problem that an enormous human step is required to look down on and analyze a contract status of an enormous number of contract documents concluded in an organization.

An object of the embodiments are to provide a document processing program and an information processing apparatus that present a contract status of an organization based on the contents of contract documents.

### Solution to Problem

In order to achieve the above object, one aspect of the embodiments provide the following document processing program and information processing apparatus.

An aspect of embodiments includes a non-transitory computer-readable medium storing a program including instructions that, when executed by a processor, causes an information processing apparatus connected to a document processing apparatus through a communication interface, to: accept a condition for analyzing a contract document by an acceptance unit; extract a contract document by an analysis target extraction unit, wherein the contract document containing information that matches to the condition accepted by the acceptance unit is extracted from a contract document database which contains a plurality of contract documents and information indicating a contract status of the plurality of contract documents, by an analysis target extraction unit; analyze the contract document extracted by the analysis target extraction unit based on the condition accepted by the acceptance unit, by an analysis unit; and display and output an analysis result of the analysis unit by the output unit.

Another aspect of embodiments includes a non-transitory computer-readable medium storing a program including instructions that, when executed by a processor, causes an information processing apparatus connected to a document processing apparatus through a communication interface, to: accept a condition related to a numerical value, a contract, and an organization for analyzing a contract document, and a method for displaying an analysis result, by an acceptance unit; extract a contract document having extraction information matching the condition accepted by the acceptance unit from a contract document database which includes a plurality of contract documents and in which information related to at least a numerical value, a contract, and an organization for the plurality of contract documents is extracted as extraction information, by an analysis target extraction unit; analyze the contract document extracted by the analysis target extraction unit based on the condition related to a numerical value, a contract, and an organization accepted by the acceptance unit, by an analysis unit; and display and output an analysis result by the display method accepted by the acceptance unit, by an output unit.

Yet another aspect of embodiments includes an information processing apparatus comprising: a communication device configured to communicate with a document processing apparatus through a communication interface; a processor; and a storage device configured to store a program including instructions that, when executed by the processor, causes the document processing apparatus to: accept a condition for analyzing a contract document by an acceptance unit; extract a contract document having extraction information matching the condition accepted by the acceptance unit from a contract document database which includes a plurality of contract documents and information indicating a contract status of the plurality of contract documents, by an analysis target extraction unit; analyze the contract document extracted by the analysis target extraction unit based on the condition accepted by the acceptance unit; and display and output an analysis result of the analysis unit by output unit.

Yet another aspect of embodiments includes an information processing apparatus comprising: a communication device configured to communicate with a document processing apparatus through a communication interface; a processor; and a storage device configured to store a program including instructions that, when executed by the processor, causes the document processing apparatus to: accept a condition related to a numerical value, a contract, and an organization for analyzing a contract document, and a method for displaying an analysis result, by an acceptance unit; extract a contract document having extraction information matching the condition accepted by the acceptance unit from a contract document database which includes a plurality of contract documents and in which information related to at least a numerical value, a contract, and an organization for the plurality of contract documents is extracted as extraction information, by an analysis target extraction unit; analyze the contract document extracted by the analysis target extraction unit based on the condition related to a numerical value, a contract, and an organization accepted by the acceptance unit, by an analysis unit; and display and output an analysis result by the display method accepted by the acceptance unit by an output unit.

Yet another aspect of embodiments includes a method for processing documents comprising: accepting a condition for analyzing a contract document by an acceptance unit; extracting a contract document by an analysis target extraction unit, wherein the contract document containing information that matches to the condition accepted by the acceptance unit is extracted from a contract document database which contains a plurality of contract documents and information indicating a contract status of the plurality of contract documents; analyzing the contract document extracted by the analysis target extraction unit based on the condition accepted by the acceptance unit, by an analysis unit; and displaying and output an analysis result of the analysis unit by the output unit.

### Advantageous Effects of Invention

According to the embodiments, the contract status of an organization can be presented based on the contents of the contract document.

### BRIEF DESCRIPTION OF DRAWINGS

FIG. 1 is a block diagram showing a configuration example of an information processing apparatus according to one of embodiments.

FIG. 2 is a schematic diagram showing a configuration of the contract document information.

FIG. 3 is a schematic diagram showing a configuration of accompanying information.

FIG. 4 is a schematic diagram showing a configuration of an information extraction screen of the information processing apparatus.

FIG. 5 is a schematic diagram showing a configuration of a screen for accepting an analysis condition of the information processing apparatus.

FIG. 6 is a schematic diagram showing a configuration of a screen for accepting an analysis condition of the information processing apparatus.

FIG. 7 is a schematic diagram showing a contract document analysis result display screen of the information processing apparatus.

FIG. 8 is a schematic diagram showing a contract document analysis result display screen of the information processing apparatus.

FIG. 9 is a schematic diagram showing a contract document analysis result display screen of the information processing apparatus.

FIG. 10 is a flowchart showing an operation example of the information processing apparatus.

### DESCRIPTION OF EMBODIMENTS

### Embodiment

### (Configuration of Information Processing Apparatus)

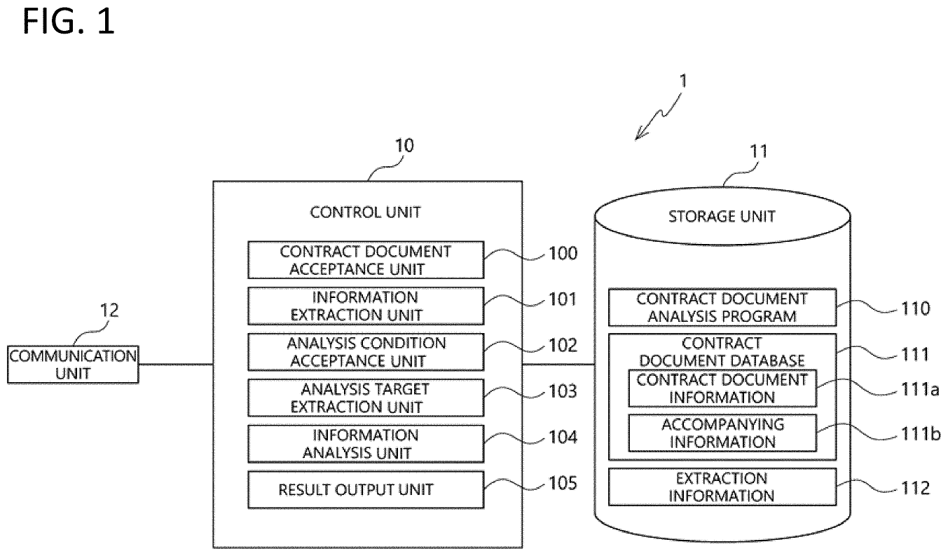

FIG. 1 is a block diagram showing a configuration example of an information processing apparatus according to one of embodiments.

The information processing apparatus 1 includes a control unit 10 that includes a central processing unit (CPU) or the like, controls each unit, and executes various programs, a storage unit 11 that includes a storage medium such as a hard disk drive (HDD) or a flash memory and stores information, and a communication unit 12 that communicates with the outside via a network. It is assumed that the information processing apparatus 1 is connected to a terminal operated by a user via the communication unit 12 and operates based on a request signal of the terminal.

By executing a contract document analysis program 110 as a document processing program described below, the control unit 10 functions as a contract document acceptance unit 100, an information extraction unit 101, an analysis condition acceptance unit 102, an analysis target extraction unit 103, an information analysis unit 104, a result output unit 105, and the like.

The contract document acceptance unit 100 accepts the input of a contract document to be analyzed and stores the contract document in the contract document database 111 of the storage unit 11 as contract document information 111a and accompanying information 111b. The contract document information 111a is information indicating the contents of the contract document (Mainly text information and layout information. The amendment history may be included.), and the accompanying information 111b is information indicating accompanying contents other than the contents of the contract document, such as the conclusion entity and conclusion partner of the contract document, the type of the contract, the position, and the status.

The information extraction unit 101 analyzes the contents of the contract document information 111a or analyzes the contents of the accompanying information 111b to extract information indicating the contract status. The method of extracting information from the contents of the contract document information 111a may be a method of extracting information matching a predetermined keyword, and a letter, a number, and the like included near the keyword, a method of extracting information by performing morphological analysis, syntax analysis, semantic analysis, and context analysis, or a method of extracting information by performing labeling based on machine learning.

The information indicating the contract status extracted by the information extraction unit 101 includes, for example, a contract conclusion date, a validity period, presence or absence of an automatic renewal, a party name, a contract type, a governing law, an agreed jurisdiction, and a contract amount. In addition, the contract contents include the object name, the object, and the consignment contents. In addition, the presence or absence of a risk clause includes the obligation not to compete, the condition subsequent, the scope of compensation and upper limit of compensation amount for damages, the necessity of prior permission in the subcontracting condition, and the presence or absence of notification duty. In addition, the prior notification matter includes the change of trade name and the change of capital. In addition, there is a post notification matter. In addition, the information extraction unit 101 may extract information to be used at the time of contract, and may further extract information set by the user.

The analysis condition acceptance unit 102 accepts a condition for extracting a contract document to be analyzed from the contract document database 111.

The analysis target extraction unit 103 extracts a target contract document from the contract document database 111 based on the condition accepted by the analysis condition acceptance unit 102.

The information analysis unit 104 analyzes the contract document to be analyzed extracted by the analysis target extraction unit 103 based on numerical information such as the amount of money and the number of cases, contract information such as a contract document term being a term used in the contract document, and organization information being a business segment in units of a company, a department, and the like in the organization. It should be noted that the information analysis unit 104 may detect the notification matter for the analysis result based on a predetermined condition. In addition, the information analysis unit 104 may perform the analysis operation based on an input condition or a predetermined condition, or may perform the analysis operation based on machine learning regardless of the presence or absence of a condition. The notification matter is detected based on conditions such as a case where the contract renewal time is in two months, for example, and in this case, the notification contents are “there are three contract documents with a contract renewal within two months” or the like.

The result output unit 105 outputs the result analyzed by the information analysis unit 104 as displayable information using figures such as letters, numbers, and graphs. In addition, the result output unit 105 may also display notification contents corresponding to the notification matter analyzed by the information analysis unit 104. The notification contents may be a message such as “there are three contract documents with a contract renewal within two months”, may be a message using an icon indicating an alert and the like, or may use a display method such as blinking a portion corresponding to the notification matter on the graph.

The storage unit 11 stores a contract document analysis program 110 that operates the control unit 10 as each of the unit 100 to 105 described above, a contract document database 111, an extraction information 112, and the like.

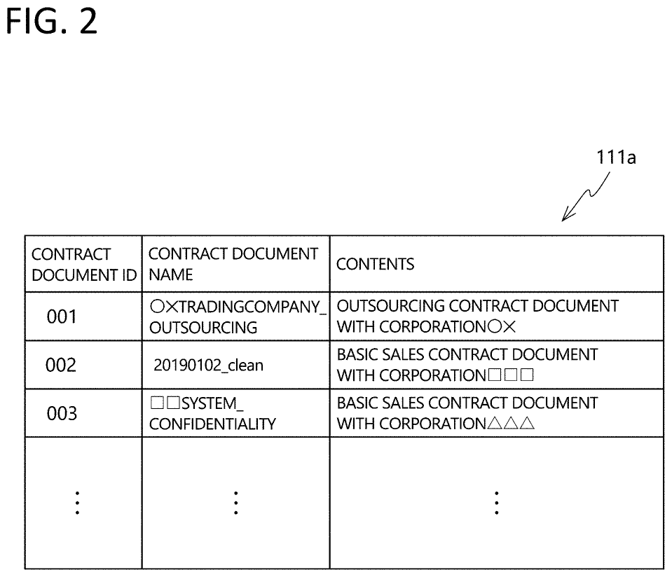

FIG. 2 is a schematic diagram showing a configuration of the contract document information 111a.

The contract document information 111a includes a contract document ID for identifying a contract document, a contract document name being a data name of the contract document, and contents of the contract document (mainly text information and layout information. Amendment history information may be included).

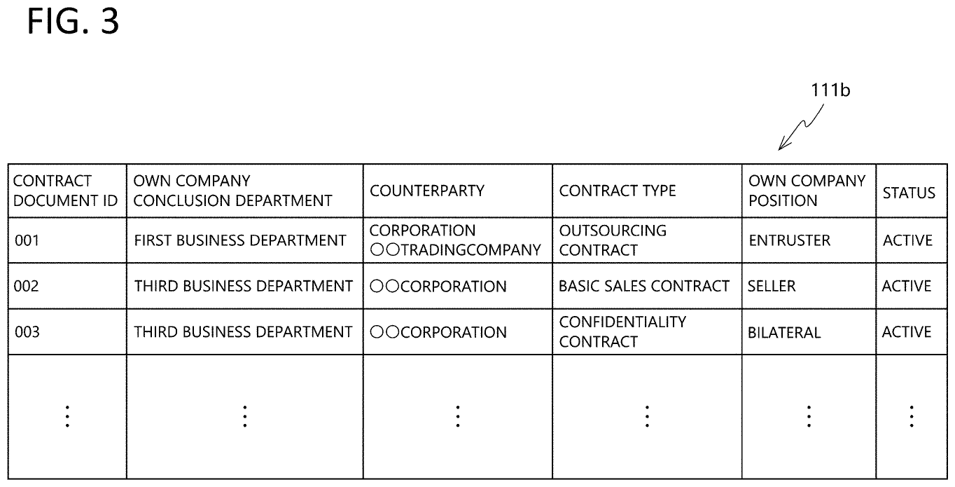

FIG. 3 is a schematic diagram showing a configuration of accompanying information 111b.

The accompanying information 111b includes a contract document ID, an own company conclusion department indicating a department name of an organization to which the user who concludes the contract belongs, a partner who concludes the contract, a contract type indicating a type of the contract document, an own company position indicating the position in the own company contract, and a status indicating “active” in which the contract document is in a contract period or “termination” in which the contract is terminated. It should be noted that the status may indicate another state such as “contract document is under preparation”.

### (Operation of Information Processing Apparatus)

Next, the action of the embodiments will be described separately for (1) information extraction operation and (2) contract document analysis operation.

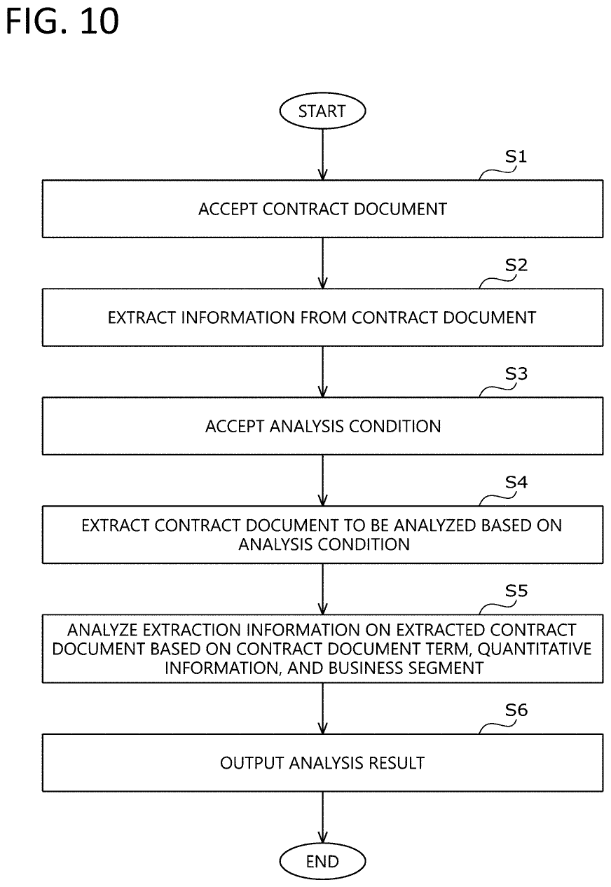

FIG. 10 is a flowchart showing an operation example of the information processing apparatus 1.

### (1) Information Extraction Operation

First, the user operates a terminal connected to the information processing apparatus 1 via a network, and inputs a contract document to be analyzed to the information processing apparatus 1. A method of inputting a contract document may include: inputting data including a text and a layout prepared by word processing software and additionally inputting or selecting information such as an own company conclusion department, a counterparty, a contract type, an own company position, and a status which are insufficient in the data; extracting insufficient data from the text portion of the data including the text and the layout prepared by the word processing software; or inputting data including a text and a layout previously input in an application for preparing a contract document or an application operating on a cloud and data accompanying the data.

The contract document acceptance unit 100 of the information processing apparatus 1 accepts the input of a contract document to be analyzed from the terminal, and stores the contract document in the contract document database 111 of the storage unit 11 as the contract document information 111a shown in FIG. 2 and the accompanying information 111b shown in FIG. 3 (S1). It should be noted that the contract document database 111 may be stored outside.

Next, the information extraction unit 101 analyzes the contents of the contract document information 111a and the contents of the accompanying information 111b to extract information, and stores the extracted information in the storage unit 11 as the extraction information 112 (S2). The extraction of the information may be performed automatically with respect to all information by text analyzing the contents of the contract document, but as described below, some information may be automatically extracted, and the remaining information may be added or selected by the user.

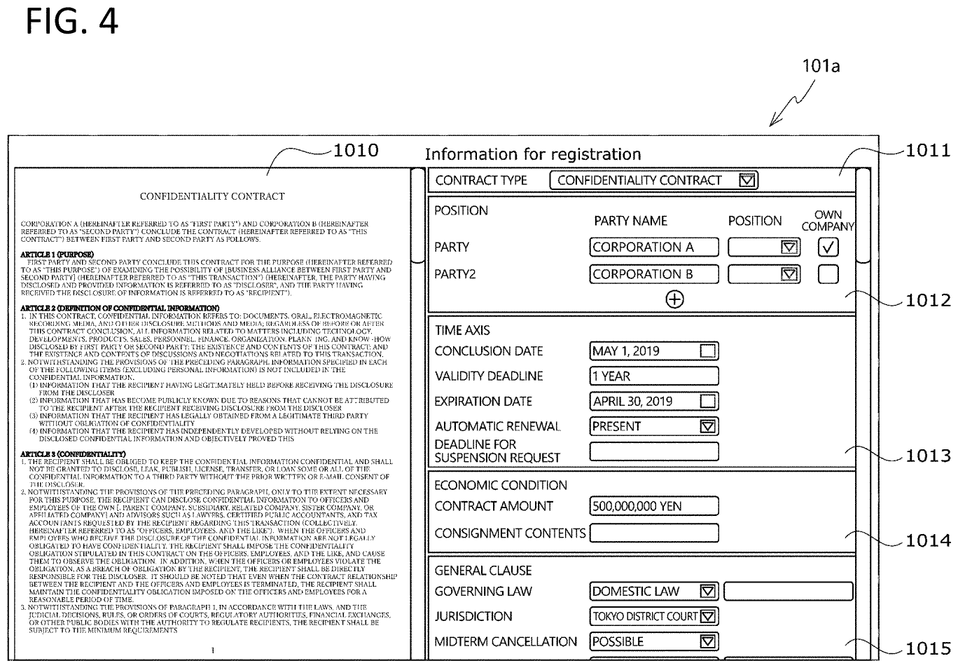

FIG. 4 is a schematic diagram showing a configuration of an information extraction screen of the information processing apparatus 1.

The screen 101a is a screen displayed on the display unit of the terminal operated by the user by the information extraction unit 101, and includes: a contract document information display field 1010 for displaying the contents of the contract document information 111a, a contract type selection field 1011 for selecting the type of the contract document, a position selection field 1012 for selecting the party of the contract document and the position thereof, a time axis selection field 1013 for selecting the time axis of the contract document such as the conclusion date and the expiration date, an economic condition selection field 1014 for selecting the economic condition of the contract document such as the contract amount, and a general clause selection field 1015 for selecting the general clause of the contract document such as the governing law and jurisdiction.

It should be noted that the contents already displayed in the contract document information display field 1010, the contract type selection field 1011, the position selection field 1012, the time axis selection field 1013, the economic condition selection field 1014, and the general clause selection field 1015 are automatically extracted by text-analyzing the contents of the contract document information 111a by the information extraction unit 101, but the extracted items may be changed by the user. In addition, the user may input and select information not extracted.

In addition, the extraction and selection items described above are examples, and it is a matter of course that other items can be extracted and selected. The information to be extracted includes, for example, a contract conclusion date, a validity period, presence or absence of an automatic renewal, a party name, a contract type, a governing law, an agreed jurisdiction, and a contract amount. In addition, the contract contents include the object name, the object, and the consignment contents. In addition, the presence or absence of a risk clause includes the obligation not to compete, the condition subsequent, the scope of compensation and upper limit of compensation amount for damages, the necessity of prior permission in the subcontracting condition, and the presence or absence of notification duty. In addition, the prior notification matter includes the change of trade name and the change of capital. In addition, there is a post notification matter. In addition, the information extraction unit 101 may extract other information as long as the information is used at the time of contract, or may further add information set by the user.

### (2) Contract Document Analysis Operation

Next, the user operates a terminal connected to the information processing apparatus 1 via a network, and inputs an analysis condition to the information processing apparatus 1.

The analysis condition acceptance unit 102 of the information processing apparatus 1 accepts the analysis condition from the terminal (S3). The analysis condition acceptance unit 102 displays a screen as described below as a screen for accepting the analysis condition.

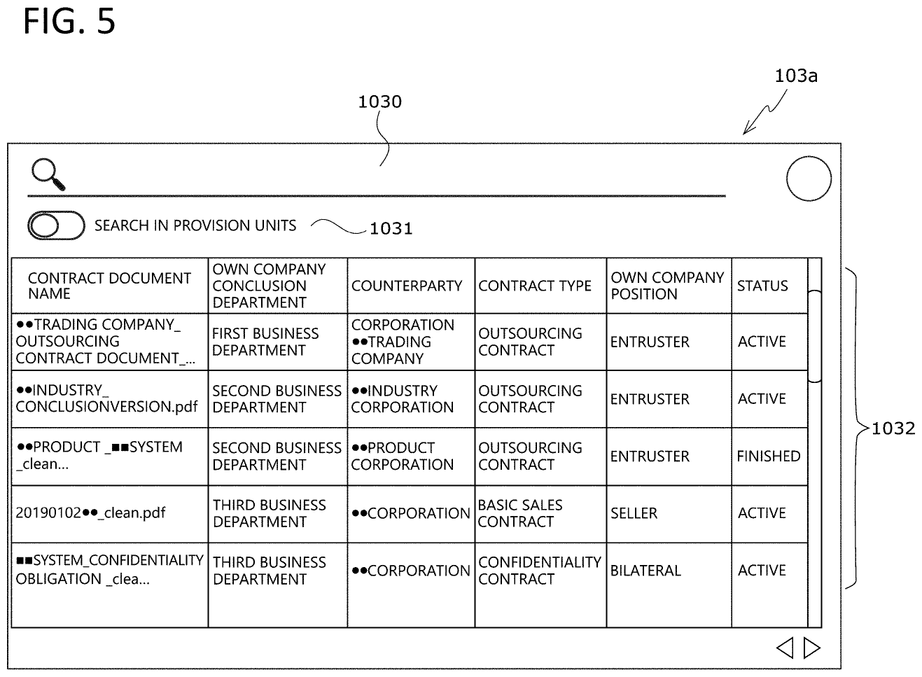

FIG. 5 is a schematic diagram showing a configuration of a screen for accepting an analysis condition of the information processing apparatus 1.

The screen 103a includes an analysis condition input field 1030 for inputting an analysis condition, a switching button 1031 for switching between searching in contract document units and searching in provision units, and a contract document display field 1032 for displaying a search result in contract document units. Since no analysis condition is input in the state shown in FIG. 5, all contract documents are displayed in the contract document display field 1032.

Next, when the analysis condition is input, the analysis target extraction unit 103 extracts a target contract document from the contract document database 111 based on the condition accepted by the analysis condition acceptance unit 102 (S4), and displays a screen as shown below.

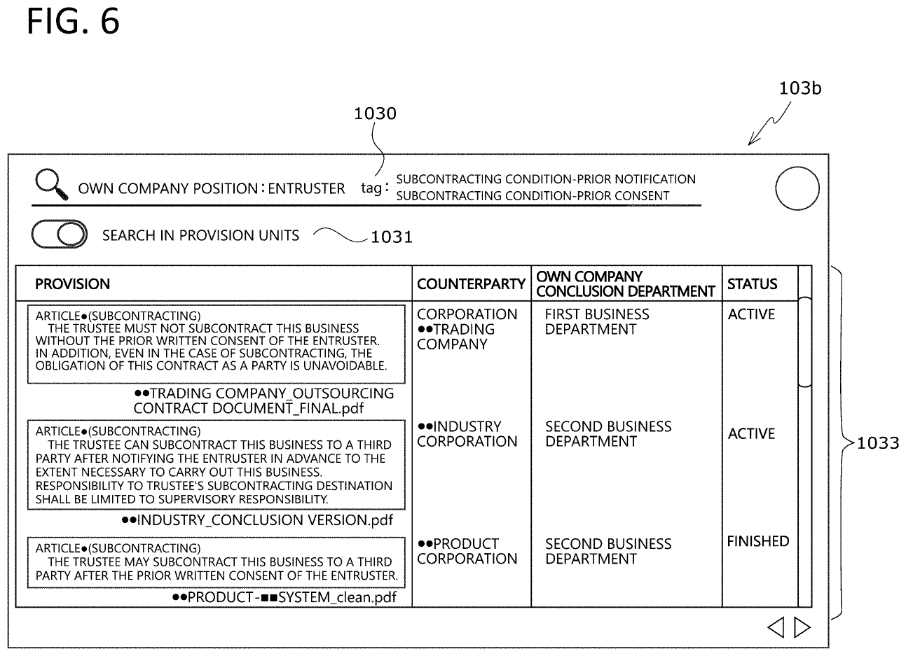

FIG. 6 is a schematic diagram showing a configuration of a screen for accepting an analysis condition of the information processing apparatus 1.

The screen 103b includes an analysis condition input field 1030, a switching button 1031 for switching between searching in contract document units and searching in provision units, and a provision display field 1033 for displaying a search result in provision units. In the state shown in FIG. 6, as the analysis condition, the “own company position” is “entruster”; as the “tag”, the “subcontracting condition” is “prior notification”, and “prior acceptance” is input. Therefore, in the provision display field 1033, provisions of the contract document that match the condition is displayed.

Next, the information analysis unit 104 analyzes the contract document to be analyzed extracted by the analysis target extraction unit 103 based on numerical information such as the amount of money and the number of cases, contract information such as a contract document term being a term used in the contract document, and organization information being a business segment in units of a company, a department, and the like in the organization (S5).

The result output unit 105 outputs the result analyzed by the information analysis unit 104 using figures such as letters, numbers, and graphs (S6).

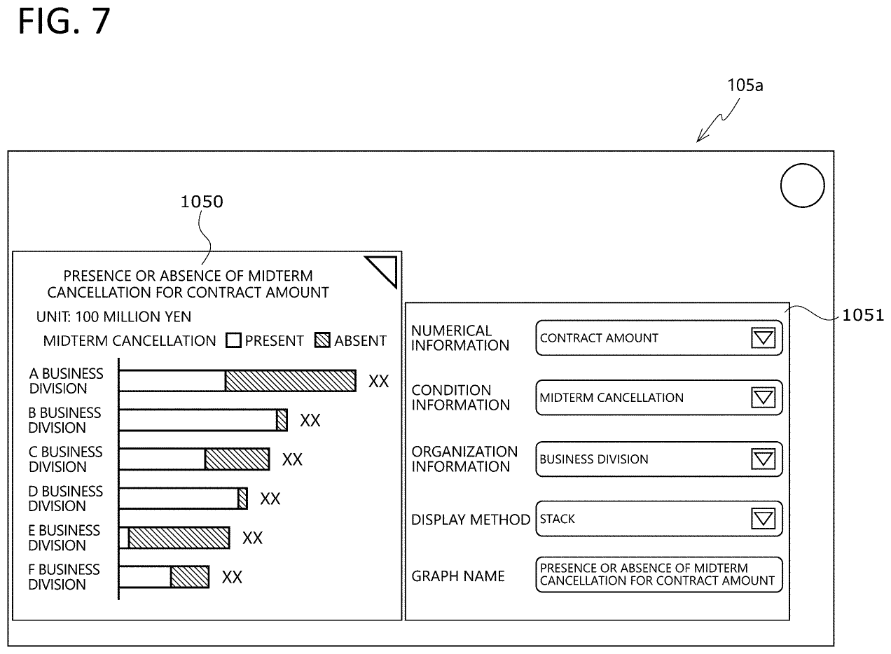

FIG. 7 is a schematic diagram showing a contract document analysis result display screen of the information processing apparatus 1.

The screen 105a includes an analysis result display field 1050 for displaying an analysis result and an analysis condition designation field 1051 for designating an analysis condition. In the example shown in FIG. 7, in the analysis condition designation field 1051, “contract amount” is selected as numerical information, “midterm cancellation” is selected as contract information, and “business division” is selected as organization information. In addition, “stack” display is selected as a graph display method, and the presence or absence of midterm cancellation with respect to the contract amount of each business division is displayed in the analysis result display field 1050 based on the selected analysis information and display method. It should be noted that as the numerical information, the conclusion date, the number of contracts, the order quantity (of products or the like), and the like can be selected. In addition, as the condition information, the presence or absence of an upper limit of the amount of damages, the presence or absence of automatic renewal, the presence or absence of obligation not to compete, and the like can be selected. In addition, as the organization information, a company, a business office, a department, a contractor, a business partner, a business type of the business partner, and the like can be selected.

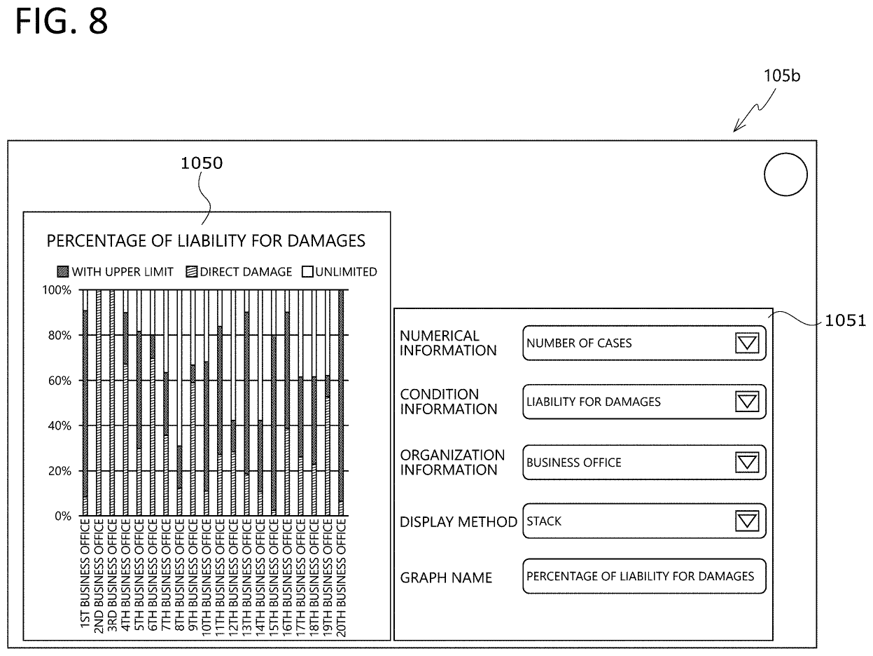

FIG. 8 is a schematic diagram showing a contract document analysis result display screen of the information processing apparatus 1.

In addition, the screen 105b includes an analysis result display field 1050 and an analysis condition designation field 1051. In the example shown in FIG. 8, in the analysis condition designation field 1051, “number of cases (%)” is selected as numerical information, “liability for damages” is selected as condition information, and “business office” is selected as organization information. In addition, “stack” display is selected as a display method of the graph, and the number ratio of the contents of damages (“with upper limit”, “direct damage”, or “unlimited”) of each business office is displayed in the analysis result display field 1050 based on the selected analysis information and display method.

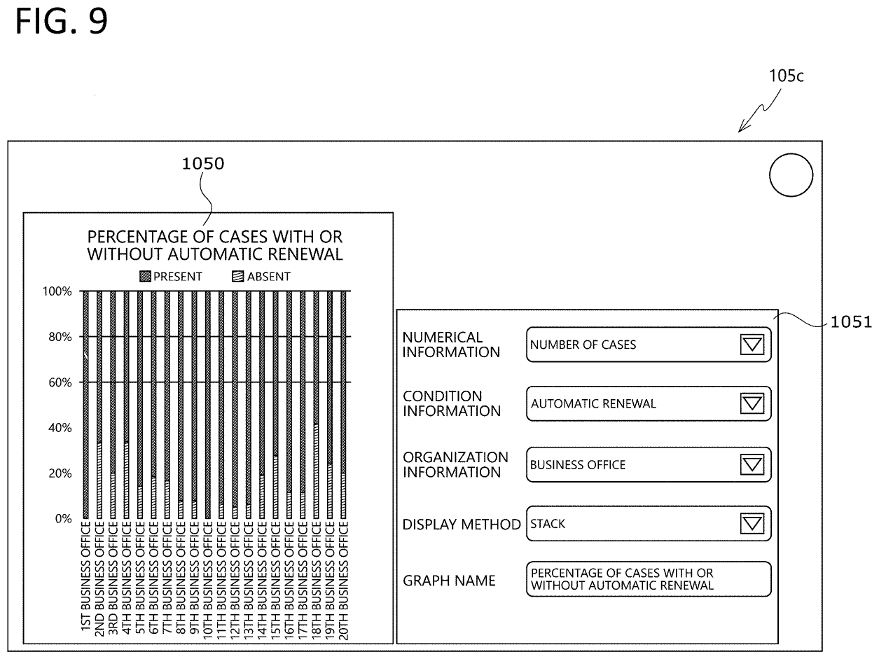

FIG. 9 is a schematic diagram showing a contract document analysis result display screen of the information processing apparatus 1.

In addition, the screen 105c includes an analysis result display field 1050 and an analysis condition designation field 1051. In the example shown in FIG. 9, in the analysis condition designation field 1051, “number of cases (%)” is selected as numerical information, “automatic renewal” of the contract is selected as condition information, and “business office” is selected as organization information. In addition, “stack” display is selected as a display method of the graph, and the number ratio of the presence or absence of the automatic renewal of the contract of each business office is displayed in the analysis result display field 1050 based on the selected analysis information and display method.

### Effects of Embodiment

According to the embodiment described above, the information indicating the contract status of the contract document is extracted from the text data of the contract document, the extracted extraction information 112 is stored together with the contract document database 111 including the plurality of contract documents, and the information on the contract document matching the analysis condition is displayed based on the numerical information (number of cases, amount, and the like), the contract information, and the organization information. Therefore, the contract status of the organization can be presented based on the contents of the plurality of contract documents.

### OTHER EMBODIMENTS

It should be noted that the embodiments is not limited to the above embodiments, and various modifications can be made without departing from the gist of the embodiments.

In the above embodiments, the function of each unit 100 to 105 of the control unit 10 is implemented by the program, but all or a part of each unit may be implemented by hardware such as ASIC. In addition, the program used in the above embodiments can be provided by being stored in a recording medium such as a CD-ROM. In addition, replacement, deletion, addition, and the like of the above steps described in the above embodiments can be performed within the scope not changing the gist of the embodiments.

### INDUSTRIAL APPLICABILITY

Provided are a document processing program and an information processing apparatus that present a contract status of an organization based on the contents of contract documents.

### REFERENCE SIGNS LIST

1 information processing apparatus
10 control unit
11 storage unit
12 communication unit
100 contract document acceptance unit
101 information extraction unit
102 analysis condition acceptance unit
103 analysis target extraction unit
104 information analysis unit
105 result output unit
110 contract document analysis program
111 contract document database
111a contract document information
111b accompanying information
112 extraction information

1. A non-transitory computer-readable medium storing a program including instructions that, when executed by a processor, causes an information processing apparatus connected to a document processing apparatus through a communication interface, to:
accept a condition for analyzing a contract document by an acceptance unit;
extract a contract document by an analysis target extraction unit, wherein the contract document containing information that matches to the condition accepted by the acceptance unit is extracted from a contract document database which contains a plurality of contract documents and information indicating a contract status of the plurality of contract documents;
analyze the contract document extracted by the analysis target extraction unit based on the condition accepted by the acceptance unit, by an analysis unit; and
display and output an analysis result of the analysis unit by the output unit.

2. A non-transitory computer-readable medium storing a program including instructions that, when executed by a processor, causes an information processing apparatus connected to a document processing apparatus through a communication interface, to:
accept a condition related to a numerical value, a
contract, and an organization for analyzing a contract document, and a method for displaying an analysis result, by an acceptance unit;
extract a contract document having extraction information matching the condition accepted by the acceptance unit from a contract document database which includes a plurality of contract documents and in which information related to at least a numerical value, a contract, and an organization for the plurality of contract documents is extracted as extraction information, by an analysis target extraction unit;
analyze the contract document extracted by the analysis target extraction unit based on the condition related to a numerical value, a contract, and an organization accepted by the acceptance unit, by an analysis unit; and
display and output an analysis result by the display method accepted by the acceptance unit, by an output unit.

3. An information processing apparatus comprising:
a communication device configured to communicate with a document processing apparatus through a communication interface;
a processor; and
the non-transitory computer-readable medium according to claim 1.

4. An information processing apparatus comprising:
a communication device configured to communicate with a document processing apparatus through a communication interface;
a processor; and
the non-transitory computer-readable medium according to claim 2.

5. The non-transitory computer-readable medium according to claim 1, wherein the instructions further cause the information processing apparatus to:
accept one or more of contract documents to be analyzed, by a contract acceptance unit,
extract information of interest from the one or more of contract documents, by an information extraction unit, and
save the one or more of contract documents and the information of interest in the contract document database.

6. The non-transitory computer-readable medium according to claim 5, wherein the instructions further cause the information processing apparatus to:
extract the information of interest by performing any of predetermined keywords analysis, morphological analysis, syntax analysis, semantic analysis, and context analysis and labeling based on machine learning.

7. A method for processing documents comprises:
accepting a condition for analyzing a contract document by an acceptance unit;
extracting a contract document by an analysis target extraction unit, wherein the contract document containing information that matches to the condition accepted by the acceptance unit is extracted from a contract document database which contains a plurality of contract documents and information indicating a contract status of the plurality of contract documents;
analyzing the contract document extracted by the analysis target extraction unit based on the condition accepted by the acceptance unit, by an analysis unit; and
displaying and output an analysis result of the analysis unit by the output unit.
